(19) United States
(12) Patent Application Publication
(10) Pub. No.: US 2012/0227044 A1
(43) Pub. Date: Sep. 6, 2012

(54) AUTOMATED WORKFLOW MANAGER

(75) Inventors: Prabhu Arumugham, Chennai (IN); Prabhu Subramanian, Chennai (IN); Karthik Viswanathan, Chennai (IN); Iyyappan Lalitha Sankaran, Chennai (IN); Senthil Kumar Gopal Ramalingam, Chennai (IN)

(73) Assignee: TATA CONSULTANCY SERVICES LIMITED, Mumbai (IN)

(21) Appl. No.: 13/211,965

(22) Filed: Aug. 17, 2011

(30) Foreign Application Priority Data
Mar. 3, 2011 (IN) 597/MUM/2011

(51) Int. Cl. G06F 9/46

(52) U.S. Cl. 718/100

(57) ABSTRACT

The present application relates to a workflow system and method that automates workflow processes across an enterprise application by using a predefined routing rule-based workflow engine to automate the processes and a highly user-friendly execution platform to realize the workflow configuration. The workflow automation system of the present application is highly streamlined, scalable, and agile. The workflow automation system also easily integrates with existing application servers without requiring any re-deployment of the enterprise application as workflow patterns or flows change in real time.

### CROSS-REFERENCE TO RELATED APPLICATIONS AND PRIORITY

The present application claims priority to Indian Patent Application No. 597/MUM/2011, filed on Mar. 3, 2011, the entirety of which is hereby incorporated by reference.

### FIELD OF THE INVENTION

The present application generally relates to a dynamic, flexible and agile tool for workflow automation to meet changing needs in organizational business models, and more particularly to a workflow system wherein a workflow engine and an execution platform is provided for on-the fly configuration of workflow without the need to redeploy the application.

### BACKGROUND

Several business processes in an organization may involve participation of people by way of initiation, approvals, or reviews to manage flow of tasks and data involved. These process solutions may demand change with their proprietary systems and data architecture to adapt them to change in resources, people, and procedure who may be employed with advanced technological solutions. The need to make such processes easily adaptable to meet changing needs in business models is indispensable.

Long and complex workflow solutions, once created, are difficult to modify and they are also incapable of keeping pace with the speed at which the technology advances. Consequently, a workflow solution to keep the flow smooth and efficient in order to drive agility and business benefits is needed.

Typically, many organizations have dynamic workflow needs and, if the workflow system itself is not dynamic, it would be painstaking to adapt to the changing workflow. There can be multiple problems faced by an organization when it comes to automating business processes. The major shortcoming is that at any time a process changes, extensive efforts are required along with additional resource consumption in terms of modeling or re-modeling the workflow or in coding and re-deploying the new workflow into the production environment. Workflows were introduced to address these problems. However, another major constraint was to develop a workflow application system which can support all sorts of developed workflow patterns like parallel routing, multi choice routing, conditional forwarding, escalation etc. The solution further required standardizing of business data that dynamically changes along with the process.

Also, most of the workflow tools available in the market serve to provide only workflow functionality and there is a need for a parent application. Other tools which offer an execution platform provide the service only in a hosted model (SaaS) and not as an application that can be deployed at the end users location.

Further, imperfections associated with developed workflow application system were taking into account SLA's and turnaround times for the workflows including the business calendar, enablement of user subscription for work flow items based on business data filtering, batch import of work items, and integrated search of work items. As is evident, manual workflow management will pose a challenge, because it is intensive in terms of time, cost, effort and resources.

Therefore, a system and a method for providing a workflow management solution which comprises a defined workflow definition and an engine to adequately model the dynamically changing business field are highly desirable. Also, such a system can comprise both workflow modeling and business data modeling capabilities that can enable ease of configuration in a real-time business environment, which can offer ease of use.

### OBJECT

In accordance with the present application, a web-based solution for workflow modeling and an execution environment to realize the dynamically modeled workflow is provided.

It is an object of the present application to provide dynamic on-the-fly configuration of workflow without need to redeploy the existing workflow application.

Another objective of the present application is to combine workflow processing techniques and interpretation of data definitions to produce an expansive and agile workflow model.

It is an object of the application to provide support for various workflow patterns including Linear, Parallel (Forking), Multi-choice routing, Looping, Conditional Forward and Escalation Workflow Patterns.

In another aspect of the present application, business data definition can be customized so that it can be linked to any workflow so as to automate the data flow process.

In yet another aspect, generic design of workflow forms may be provided with the ability to add or modify business fields to the form dynamically without any code change or without requiring re-deployment of the application.

It is another object of the present application to provide an execution platform inclusive of work item, inbox, history, etc.

One of the objectives of the present application is to generate alerts for workflow actions and for data changes in case of parallel work flows.

Yet another objective of the present application is to enable static and dynamic form validation for the workflow forms.

In another aspect of the present application, multi tenant support may be provided.

### SUMMARY

The present application is directed to a system and method for providing workflow automation across an enterprise application. The solution provides both a workflow engine that will automate workflow processes and a highly user-friendly interface that can help users create their own business data on the fly without coding. In one aspect of the application, the processes can be executed and visualized within the same application interface without redeploying the application for changes in workflow patterns. The present application, thus, provides an execution platform that can be deployed at the user end location to realize workflow configuration without requiring re-modeling of the workflow processes since workflow relevant information is stored directly in a relational database.

According to one general aspect, a data modeler component of the present application facilitates dynamic creation of business data fields in the form of attributes as key value pairs which holds all the information about all the fields in the process in a tabular format. The change in the workflow pattern or order does not require changes in business filed by way of altering the table definitions in any way. Thus, the flexibility in modeling the business data fields is dynamically achieved while supporting multiple routing patterns during execution of a workflow process.

In another aspect of the present application, the workflow process can be executed and visualized on any other existing application that is capable of interfacing with the workflow engine directly.

These and other aspects, features and advantages of the present application will be described or become apparent from the following detailed description of preferred embodiments, which is to be read in connection with the accompanying drawings.

### BRIEF DESCRIPTION OF THE DRAWINGS

FIG. 1 illustrates implementation of flexible workflow management system according to exemplary embodiment of the present application.

FIG. 2 is a block diagram of a process model of workflow architecture for executing an activity instance according to one aspect of the present application.

FIGS. 3A & 3B illustrates deployment of the workflow engine with any existing application server according to an embodiment of the present application.

FIG. 4 depicts the storage of workflow relevant information in accordance with one general embodiment of the present application.

FIGS. 5A-5D show examples of various workflow patterns as supported by the workflow engine during execution of any process instance based on routing definition and criterion.

### DETAILED DESCRIPTION

Before the present method, system and communication enablement are described, it is to be understood that this application is not limited to the particular methodologies, and hardware and network described, as these may vary within the specification indicated. It is also to be understood that the terminology used in the description is for the purpose of describing the particular versions or embodiments only, and is not intended to limit the scope of the present application, which will be limited only by the appended claims. The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items. Further it is to be noted that the terms “performance testing” and “load testing” are interchangeable. Further terms “enterprise application” and “web application” are interchangeable. The disclosed embodiments are merely exemplary methods of the application, which may be embodied in various forms.

As used in this application, the terms “component/module” and “system” and the like are intended to refer to a computer-related entity, either hardware, a combination of hardware and software, software, or software in execution. For example, a component/module may be, but is not limited to being, a process running on a processor, a processor, an object, an instance, an executable, a thread of execution, a program, and/or a computer. By way of illustration, both an application running on a computer and the computer can be a component. One or more components/modules may reside within a process and/or thread of execution and a component/module may be localized on one computer and/or distributed between two or more computers.

The present application is directed to an easily configurable network enabled automated workflow management system that provides web based workflow solutions in a dynamic production environment and facilitates monitoring of the workflow processes in real time. Further, the present application makes the dynamically changing workflow processes easily adaptable to meet changing needs in business models in the enterprise environment, thereby keeping the flow smooth and efficient by driving agility and deriving business benefits.

The solution proposed in the present application involves people participation as with initiation, approvals or reviews which otherwise becomes painstaking if changing business models in the dynamic business environment are not made to be adaptable to changing workflows. The present application helps in workflow automation. It provides both a workflow engine to automate the process and also a highly user-friendly interface that can help business users create their own business data on the fly without coding. Furthermore, the solution minimizes the effort, cost, risk associated with manual workflow management, increases productivity, and facilitates greater collaboration across the enterprise.

Workflows in many organizations involve complicated processes with parallel, conditional, multi-choice, backward and other flows or routing patterns. Besides, business processes change quiet often and workflows are in frequent need of modification. Manual workflow management poses a challenge because it is intensive in terms of time, cost, effort and resources. Automating routine workflows brings in uniformity and enhances productivity.

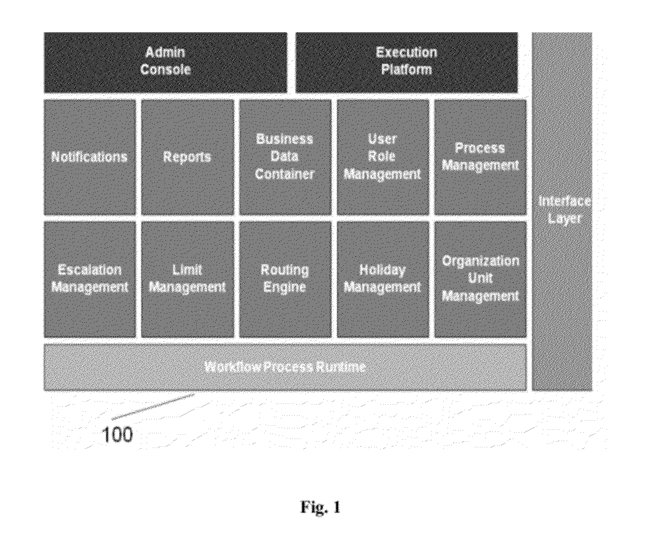

FIG. 1 shows the implementation of flexible workflow management system on a screen display according to an embodiment. The system 100 for workflow automation comes with a workflow engine that serves as a black box for any existing application. The workflow system 100 is a web enabled complete human workflow modeling and execution platform. In other words, the system 100 of the present application provides a modeling and execution platform along with the workflow engine to provide a configurable workflow application, with form designers involving zero development effort.

The workflow system thus provides a workflow development environment complete with the framework, tools and components necessary to create customized workflow solutions that integrate seamlessly with existing IT infrastructures. For the deployment of these solutions, the workflow system provides a uniform and scalable support infrastructure within the enterprise through a web-based interface. Unlike other workflow solutions which are window-based, the workflow system is web-based which means that the workflow system is accessible from a web browser.

Some key features of the workflow application system that provide for configuration or design of the business processes along with an execution engine, as presented in FIG. 1 include: configuration of processes completely with work steps, role assignments and routings; ability to support configuration of all complex workflow patterns as specified by Workflow Management Coalition (WFMC) standards; design generic forms for the process; capable of changing process steps and flows without hampering existing process transactions; real time monitoring and validation through dynamic generation of dashboards; a scalable solution capable of handling all workflow patterns-linear, parallel (forking), multi-choice routing, looping, conditional forward, escalation workflow patterns; facilitating easy creation and modification of the process model with zero coding or programming efforts; automatic notification by way of alerts of the workflow actions to be taken in a route and also for data changes in case of a parallel flow; accessibility from external systems like web browsers via web services and an execution interface which allows the user to create customized data field definitions associated with a task or an activity for realizing the workflow configuration in real time by inter-engaging with the workflow engine or existing applications and the execution platform being inclusive of work item inbox, history etc; enables process versioning; avails role based privileges for process steps (or user based or weighted round robin work allocation among resources); providing integrated business or holiday calendar management and reporting framework beside providing multi tenant support on the same platform across an enterprise.

The workflow system 100 provides a workflow process run time depiction which empowers business groups to collaboratively plan, automate, track, and improve business processes. The workflow system is not only a model of the workflow, but is a development environment/tool for developing the workflow system/model. The workflow system empowers the end user in developing and manipulating workflow processes. It allows the knowledge worker to define sufficiently meaningful workflow processes without any knowledge of programming. The knowledge worker does not need to write a single line of code in order to add to or develop the workflow system. This results in a streamlined, scalable, and agile solution that is easily integrable with existing systems. It thus increases productivity and reduces costs.

The already existing solution systems catering to workflow needs are available but these are heavy weight in terms of the time to set up and go live and also with the ease of configuration. Also for certain business processes, these solutions prove to be overkill. Either the process of configuring the workflow is difficult or bringing in a change into the existing workflow is not instantaneous. The workflow has to be remodeled and the application has to be redeployed with the new workflow. On the contrary, in the present application, on-the-fly configuration of workflows without redeploying the application is easily achieved. Usually in the other tools, the workflow model has to be exported into the resident application and the application has to be redeployed for a change in the workflow. With the present application, since the workflow information is stored directly in a relational database, there is no need for recompile/redeploy whenever there is a change in workflow.

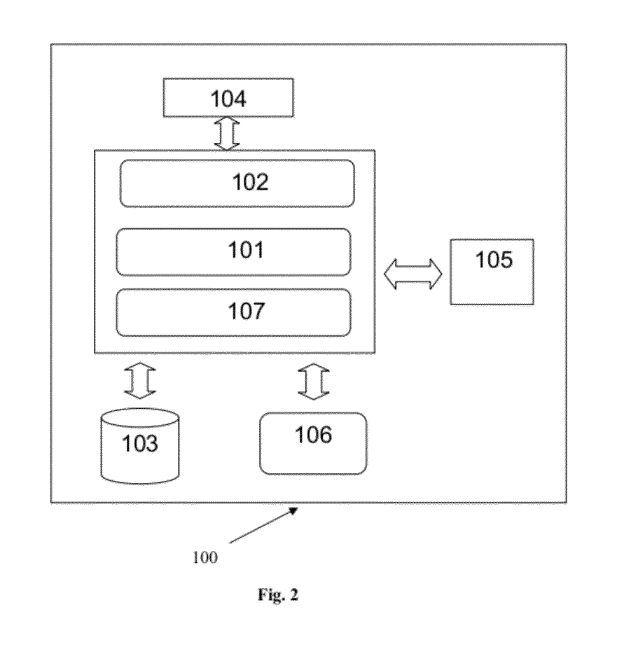

Referring to FIG. 2, the workflow system 100 comprises a workflow engine 101, an application interface which provides an execution platform 102, a storage medium in the form of database 103, a user 104 and an external system 105 with which the system 100 is integrated in real time using web services. The system 100 in itself provides an execution platform 102 and hence the need for another resident application to realize the workflow is eliminated.

The workflow engine 101 forms the integral part of the proposed system 100 in the application. It is a plug-in component that that exposes all the functionalities of a typical workflow tool. It collects the process definitions and properties in a set of tables and it is using this information the engine is able to automate the flow. The workflow related information like the steps that constitutes the flow, the routes that make the workflow, the rules that decide the route, the roles that can act on these steps, the users that belong to the role, etc. are collected as a part of the workflow configuration. At runtime, the workflow engine 101 uses these configurations and determines the next step in the workflow where the item has to be parked.

The workflow engine 101 is available as a deployable Enterprise Java Bean (EJB) in the form of a Jar file (shown as a File system 106) which can be deployed on any J2EE compliant Application server. The relational database is managed at the storage medium 103 by Java Persistence API 107. The system 100 utilizes the functionalities of the Core engine via Remote Method Invocation (RMI) calls. Any application needing a workflow capability can use the workflow engine 101 in a similar way.

In the preferred embodiment, the web based system 100 comprises the following components: a deployable workflow engine capable of being integrated with any existing application server, wherein the engine stores at a storage medium 103, the modeled process routing definitions, predefined routing rules, routing types and other workflow process related information to determine the order in which the scheduled instances of activities can be routed and enacted for automating the workflow process; and

an execution platform 102 that inter engages with the workflow engine 101 to realize the configurable workflow application by generating customized data definition fields and process related metadata information that is dynamically modeled using a key identifier associated with the said data fields and a validation mechanism operable to track the sequence of constraint specific instances of activities.

The workflow engine 101 resides on an application server within a communicating network and is Java based.

The execution platform 102 adds the business data on top of the workflow engine 101. The data model of the interface facilitates dynamic creation of business fields called as attributes. The administrator at any time can go and add, delete or modify an attribute dynamically.

Unlike conventional applications, the business fields are not stored in a columnar format in the RDBMS. Rather, the fields are stored in the form of Key-Value pairs. A table in the schema holds information about all the data fields in the process. The run time values for the data fields are stored in columns; they are stored as rows with the key representing an identifier to the field and the value storing the run-time data for the field. Thus, any new addition or deletion of a business field will not alter the table definition in any way, but just add a new row in case of a new field or delete an existing row in case the field is deleted. This way flexibility in the modeling the business field dynamically is achieved.

The execution interface platform 102 handles the dynamic business field definition and relies on the workflow engine 101 to cater the workflow needs. The workflow engine 101 supports multiple routing patterns like Serial flows, Parallel flows, Escalation flows, Conditional Forwards, Backward flows and auto approvals.

All these configurations are provided by the administrator and they are stored in a set of tables.

When a step in the workflow is initiated, it is assumed to be the first step in the workflow and the engine 101 tries to find the next step in the workflow from the process model that was configured by the administrator. There could be more than one possible outgoing route from a given step in a process route. In the preferred embodiment, the required step is identified by the string called Routing Criterion.

The selection of Routing Criterion could also be automatic with the help of predefined routing rules called Decision Logic. The Decision Logic is English-like language written in a scripting language called Apache Velocity Script. This routing rule can be written to include the fields in any combination of logical, comparison and other String functions to give out a Routing Criterion which can be used to determine the flow, in case there is more than one outward route from a given step. Thus the actor on the step need not always know which route to choose; rather the business data could drive the workflow dynamically.

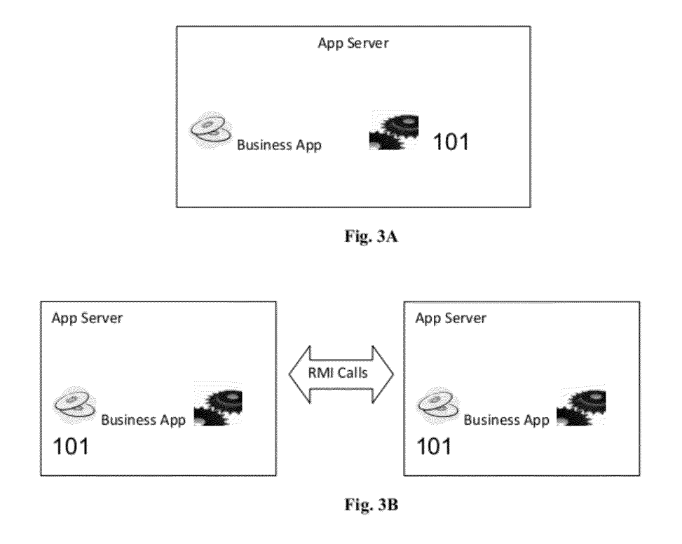

Once the process is modeled by way of customizing the data fields and processes and other related metadata information using key pair identifier, the process can be executed and visualized either within the execution platform 102 of the system 100 or with any application that will interface with the workflow engine 101 directly. The workflow engine 101 can be either deployed in an application server as shown in FIG. 3A or it can also be included in the class-path of an application and used similar to any other library as depicted in FIG. 3B.

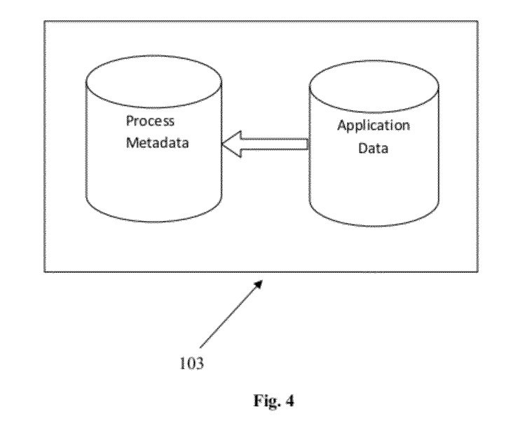

FIG. 4 depicts the storage of workflow relevant information in accordance with one general embodiment of the present application. The tables in which the workflow engine 101 stores the process metadata can either exist in a different database schema or even co-exist along with the other application tables in the same database schema. This provides the flexibility for calling applications to manipulate the workflow data if there is a need for the same.

The database schema 103 also maintains the User based and the role based information either in the workflow engine schema 101 or in the application's schema with just a database view in the workflow engine schema pointing to the application schema's database tables. This approach gives added flexibility of storing the user and role information in one place.

The workflow engine 101 supports three different work allocation strategies as discussed above. A work item can be configured to go to a role pool. In this case the work item is available for all the users tagged to the role pool. Hence when an actor decides to act on a role pool item, he will have to claim the item to bring it to his bucket. A claimed item is no longer available for view/acting for others in the role pool. A user can also release the item back to the role pool in case he does not want to act on that item. Now the released item is once again available for all the users in the role pool.

A second work allocation strategy is where an item is directly put to a users bucket. The workflow engine 101 will accept the user and assign the item to the passed user directly.

The third work allocation strategy is a weighted round robin based allocation where the work item is allocated to the least loaded user. The load of a user is a product of the number of items the user has in his bucket and the weight of each item, which is assigned by the process administrator for every step in the workflow.

The decision logic or the predefined routing rule for determining the next route in the workflow is also stored in the database 103. Since this rule is stored in the database only and not outside the application, there would be no need for redeployment of the application when the administrator modified any of the rules. The rule will be applicable on the fly. Since the apache velocity language is very flexible and powerful, one can also write any functions using the scripting language to achieve complex business rules. However if a new function is written using the Velocity script, this would require a redeployment of the application.

There are two means to store the business data. In case the components of the system 100 is used as it is, the business data can be created and stored in the execution platform 102 directly. Whereas applications can also maintain and store the business data and just pass on the necessary business data with which workflow decisions are to be made, to the workflow engine 101. The workflow engine 101 stores the business data in form of abstract keys. The workflow engine 101 provides provision for storing 30 business keys in accordance with one of the embodiments. Each business process can store its necessary data into the business keys. All the keys are of string data type. The calling application can thus store any data in the keys and then convert them back to the required data type. Thus the keys can hold any data as long as the application maps what keys contain what values, per process. This avoids the need for creating numerous columns, one for every business field.

The workflow engine 101 is one of the main components of the present application and can cater various workflow patterns for various business scenarios. A process routing definition is a route in the workflow, which will decide the flow and pattern of a process route. All the routing definition modeled in the tool can have only one step as the completed step (From Step). The completed step indicates the task that is currently being acted upon. The other end of the routing definition (To Steps) can have one or more steps.

One of the exemplary embodiments describes a method of automating the workflow process in a dynamic production environment through execution of the sequence of instances of activity of the process flow model across an enterprise application within a communication network wherein the said method comprises the processor implemented steps of:

defining and storing one or more data field definitions, routing definitions, routing rules, routing constraints and other related metadata information to trigger workflow processing;

specifying the routing constraints to assign predefined values to valid subsets of the instance of activities;

determining the subset of activity instance scheduled for enactment based on routing criteria and associated routing constraints;

analyzing the defined workflow related information and subset of activity instances received via signals from the storage medium of workflow engine to produce therefrom workflow models on said network equipment; and

initiating a workflow based on the analyzed information and workflow model so generated.

The execution platform 102 of the system 100 provides the additional functionality of defining dynamic business fields over the workflow to provide a complete execution platform. The administrator can control what business fields should be viewable and editable across different workflow steps. The tool allows creation of various input elements as business fields like Text Box, Text area, Single Select box, Multi Select box, Radio buttons, Check boxes, Attachments, Date fields, etc. The Administrator can define a business field and also specify the screen representation for the business field. This information is stored in the database 103. When rendering the screens for the process steps, this configuration is read and the screen is dynamically rendered. Thus if the administrator changes any of the routing rules, it can be rendered dynamically on screen without a need to redeploy the application.

The business fields provide the facility to define dependant combos, where the choice (value) of one of the select box determines the values of another select box. Follow-Up fields can also be configured where an answer (value) for a particular business field triggers display of one or more fields on screen. Given a list of values for a business field, the administrator can configure what subset of values should be displayed for a given workflow step. This is done after specifying the routing constraints which assigns predetermined values to the valid subsets.

Also certain business conditions require the business fields to be assigned some default values based on the steps reached in the workflow or as determined by the routing constraints. This can be achieved on the execution platform 102 by specifying the default values for the business fields against the routing definitions. Hence when a route is taken, the default values configured for that routing definition using routing constraints are assigned to the business fields automatically.

Thus once the valid subset of an activity or task is received from the storage medium workflow model for the process route is generated thereon. This initiates the workflow for the particular process route and automates the workflow process.

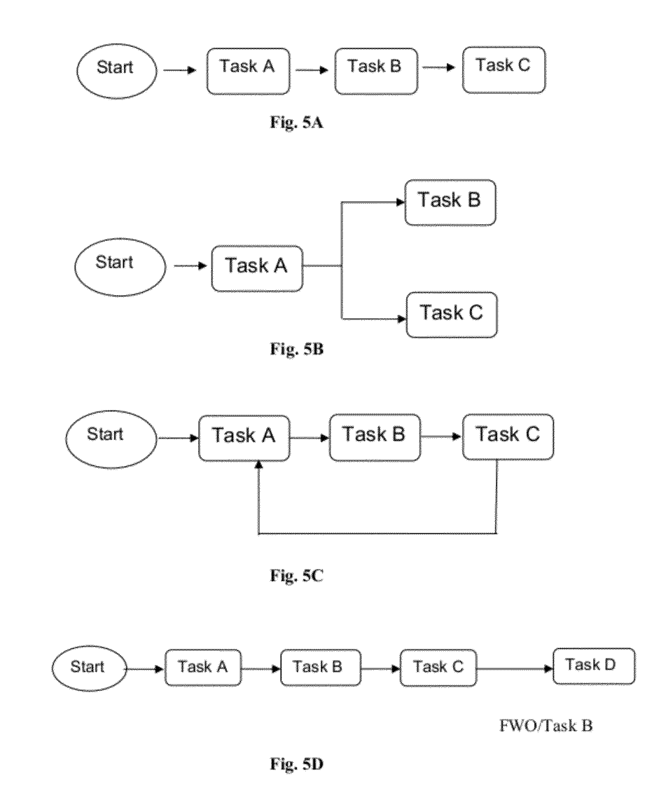

Different workflow patterns can be supported by the alternative embodiments. This can be viewed in light of FIG. 5A-5D.

FIG. 5A illustrates a linear workflow pattern wherein one current step leads to only one next step in the process flow. This is modeled with a routing definition having only one From Step and one To Step. When an item is completed, an entry is made to only one next item.

A parallel flow or forking referred in FIG. 5B is a scenario where one completed step can lead to many next steps. This is modeled as a routing definition with one completed step (From Step) and two or more pending steps (To Step). In a parallel flow multiple work items are created for the different steps in the flow and allocation for each of the step is made based on the step configuration by the administrator. Also in case of a parallel flow, at runtime, the flow need not necessarily go to all the parallel steps modeled, but based on some rules; it can be only put to a sub set of the configured parallel steps. The routing rules can also be configured to manage the merging of the parallel steps. The administrator, based on the business scenario can configure whether all the parallel steps need to be completed or only a sub set of the parallel steps need to be completed, to proceed further with the flow. This gives control over merging the parallel flows to continue the flow forward.

A backward flow as shown in FIG. 5C is a flow where the current step leads to one of the already taken steps in the workflow. This flow could be used in scenarios which involve a rejection flow, or sending the item back to an already taken step. In case of a backward flow, the work item can be configured to go either to the same person who acted on the item in the previous run or the item can be put the role pool again.

Another workflow pattern that the engine 101 supports is a Conditional forward flow illustrated in FIG. 5D where a new work item (step) has to be assigned to a same user who acted upon some previous step in the workflow. For say, in this case, the task D is put to the same person who acted upon Task B. Here the administrator configures the To Step of the routing definition with an additional previous step. It is the actor of this previous step that the new work item is put to.

Similarly Escalation flows are useful in scenarios where a step has to be completed within a given SLA. The Process Administrator can configure a timeline for a step within which it has to be acted upon. If there is a breach in the SLA, then the administrator can also model an escalation flow for that step, in which case the item will be escalated from the defaulted step to another step as modeled by the administrator. Yet another pattern, escalation with option is a flow where the item is retained with the defaulter and also an additional item is put a new step that the administrator can model. In this case, if one of the step is acted upon (either the defaulter, or the actor to whom the item is escalated to) then the other step will be made obsolete and the flow will continue normally from then on.

Whenever an item is completed or acted upon, the engine 101 updates that task or the activity and tries to find all the available outgoing routes (routing definitions) from that completed task.

The following are conditions and the actions that the engine may encounter or take:

There are no outgoing routes from the current task: This is the simplest scenario where there are no further actions to be taken and the engine completes the workflow here.

There is a routing definition with one next step in the forward direction wherein the engine creates a new item for the next step in the pending state. It also does the allocation to the step based on the configuration.

There is also a routing definition with multiple next steps in the forward direction and there is no pending step override configured. In such a case, the engine creates one work item per next step for all the available next steps in the routing definition and marks them all pending.

Further, there is a routing definition with multiple next steps in the forward direction and there is a pending step override configuration available. The pending step override configuration is used in cases, where only a subset of the configured parallel steps is to be taken. The workflow engine evaluates the pending step override logic and gets the subset of steps for which the items has to be created for and makes entry in the workflow transaction table for these items.

There are many outgoing routing definitions in which the engine evaluates the decision logic of the completed step and arrives at one routing definition. This routing definition is considered as the outgoing route and new work items are created based for the next step(s) of this selected routing definition, based on the applicable routing rules.

There is a routing definition with one next step in the backward direction. In this case, the workflow engine creates an entry for the next step which is actually one of the already taken steps in the workflow. A backward flow is ideal for scenarios which would need a set of steps to be taken repeatedly, ideally for rejection and repeat workflows. Hence the set of steps that were acted in the previous run should be nullified and new entries should be created for the steps that are being repeated.

There is a routing definition with one next step and the direction is ‘Forward with Options’. In this case, the ‘To Step’ has an additional configuration where the user of some previous step in the workflow is chosen, to whom the next step is also sent. Here the engine gets all the completed items for that particular transaction and tries to find the user who acted upon that step which was provided along with the ‘To Step’. Then a new item is created and allocated to this person who also acted upon that selected ‘To Step’.

There is a routing definition with one next step and the direction is Escalation. In this case the engine marks the current status item that was defaulted to ‘E’ and creates a new entry for the step which is marked as the step to which the item has to be escalated to. This new item is always put to the role pool.

There is a routing definition with one next step and the direction is Escalation with Copy. In this case the engine still retains the current item that is defaulted. It also creates an entry for that step which is marked as the step to which the item has to be escalated to. Now there are two items pending, one with the defaulter and the other with the role to which the item has been escalated to.

Thus, it can be observed that various routing definition directions influence the workflow engine's determination of a route.

The engine 101 also supports a delegation feature. If an actor for any reason is not able to act on an assigned work item, he has the choice of passing on an individual item to another actor of his choice. The actor is shown a list of users who are tagged to the same set of roles that is privileged to do the current step and the actor can select one user to delegate the item to. The process administrator can configure whether the step can be delegated by the current actor or not. He can override this setting at any time dynamically. It is based on this setting that the option of delegation is either enabled or disabled to the current actor.

The engine 101 also provides a feature of putting an assigned work item on hold. An actor can put an item on hold when he feels that he would not be able to proceed with the item for want of some information. Usually the time taken by an actor to act on the item is calculated by the difference between the completion time and entry time of a given work item. In case the item is held by an actor, the held time is not accounted against the actor. This would be useful in computing the productivity of an individual. This can also be used to calculate the Turnaround Time (TAT) of the work items. An actor can put an item on hold any number of times. Whether a work item can be held or not can be configured by the administrator. It is based on this setting, at the runtime; the Put on Hold' option is made available to the actor. Every time the item is held and released back to his bucket, the timestamps are captured and this data can be used to calculate the Turnaround Time and the productivity time.

The engine 101 provides a Proxy feature where individual users can configure proxies for given time duration. A user has the option of configuring proxy users for all the steps in a workflow that is entitled to act upon. He could select individual steps in the workflow and specify the time duration and the user who will act as proxy for the specified duration. Now all the items assigned to the actual user for that step in the specified time duration will also be available for the user acting as the proxy. Either of the users can act on the item and the information is captured.

The engine 101 also provides a mailing feature, which will be used to send mails to actors. The escalation and mailing features are handled by a component called the Quartz scheduler. The scheduler is a component that does some configured activity in repeated intervals of time. Whenever a work item is created, the engine checks if there are any escalations configured for that item. If so the engine notifies the quartz scheduler to create a thread which will escalate the item in case the SLA is breached. The thread is alive until the item is acted upon. In case the item is acted before the SLA, the thread is killed. In case the item breached the SLA, the thread executes and escalates the item. In case of the mailing component, the thread runs repeatedly at the configured time interval and sends the necessary mails to the SMTP server.

The workflow engine 101 has an auto approval feature where the item will be automatically acted upon after the time limit configured by the process administrator. The working is similar to the escalation feature, where a thread is created when an item is created for the step that has auto approval configured. If the item is acted before the configured time limit, the item moves to the next step. If the item is not acted until the configured time limit, the thread takes control and automatically moves the item to the next step as configured in the routing definition.

The workflow engine 101 exposes the above functionalities as java APIs. Any application can utilize these functions by passing the necessary parameters. There are APIs available for various functionalities like creating a new workflow; routing a workflow from one step to another; getting the work items pending directly with a person; getting the work items pending with the role pool of a person; claiming a work item from a role pool; terminating a work item or delegating a work item.

The workflow engine 101 also provides a process copy feature where an existing process definition can be copied to another process definition with the same name. However the start and end date of the new process should not overlap with the existing process. This feature can be used to version processes. Whenever a workflow is initiated, the engine will create an instance for that process which is active based on the current date.

The various configurable properties of workflow tasks, as discussed above, like whether the task can be reassigned, delegated, held, assigned to a proxy and all other properties are stored directly in the database 103 and not along with a model in the application as most of the other tools do. Hence whenever there is a change in the configuration, the application can read this change directly from the database 103 and dynamically cater the change instead of a need for redeploying the application.

The system 100 also contains a feature where at the end of every step in a workflow, a web service can be invoked. The process administrator can configure the web service details for every step. Once the step is acted upon, the configured web service will be invoked. The details of the business fields will be made available to the web service by the execution platform 102 of the system 100. The web service can be utilized to write any arbitrary functionality using the business data like updating an external database or system.

The system also provides an SLA based alert feature. Every process step can be specified an SLA limit. When the work item crosses the SLA, corresponding color codes are displayed along with the item. The administrator can configure the time duration after which the item should be shown with an Amber color indicator and the time duration after which the item should be shown with a Red color indicator.

Further, the system is also multi-tenant which is capable of hosting different clients. Each client can have one or more processes and business entities. However one client will not know the existence of the other. All the processes, users, roles and business entities of one client will not be visible to the other clients within the same deployment. This feature can be utilized when a single hosted application needs to be deployed to multiple clients and each client should be kept shielded from all other clients.

A system and method has been shown in the above embodiments for the effective implementation of a network-enabled automated workflow system that is integrated with a intelligent workflow engine and an execution platform. While various preferred embodiments have been shown and described, it will be understood that there is no intent to limit the application by such disclosure, but rather, it is intended to cover all modifications and alternate constructions falling within the spirit and scope of the application, as defined in the appended claims. For example, the present application should not be limited by software/program, computing environment, or specific computing hardware.

The methodology and techniques described with respect to the exemplary embodiments can be performed using a machine or other computing device within which a set of instructions, when executed, may cause the machine to perform any one or more of the methodologies discussed above. In some embodiments, the machine operates as a standalone device. In some embodiments, the machine may be connected (e.g., using a network) to other machines. In a networked deployment, the machine may operate in the capacity of a server or a client user machine in a server-client user network environment, or as a peer machine in a peer-to-peer (or distributed) network environment. The machine may comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The machine may include a processor (e.g., a central processing unit (CPU), a graphics processing unit (GPU, or both), a main memory and a static memory, which communicate with each other via a bus. The machine may further include a video display unit (e.g., a liquid crystal display (LCD), a flat panel, a solid state display, or a cathode ray tube (CRT)). The machine may include an input device (e.g., a keyboard) or touch-sensitive screen, a cursor control device (e.g., a mouse), a disk drive unit, a signal generation device (e.g., a speaker or remote control) and a network interface device.

The disk drive unit may include a machine-readable medium on which is stored one or more sets of instructions (e.g., software) embodying any one or more of the methodologies or functions described herein, including those methods illustrated above. The instructions may also reside, completely or at least partially, within the main memory, the static memory, and/or within the processor during execution thereof by the machine. The main memory and the processor also may constitute machine-readable media.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine readable medium containing instructions, or that which receives and executes instructions from a propagated signal so that a device connected to a network environment can send or receive voice, video or data, and to communicate over the network using the instructions. The instructions may further be transmitted or received over a network via the network interface device.

While the machine-readable medium can be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure.

The term “machine-readable medium” shall accordingly be taken to include, but not be limited to: tangible media; solid-state memories such as a memory card or other package that houses one or more read-only (non-volatile) memories, random access memories, or other re-writable (volatile) memories; magneto-optical or optical medium such as a disk or tape; non-transitory mediums or other self-contained information archive or set of archives is considered a distribution medium equivalent to a tangible storage medium. Accordingly, the disclosure is considered to include any one or more of a machine-readable medium or a distribution medium, as listed herein and including art-recognized equivalents and successor media, in which the software implementations herein are stored.

The illustrations of arrangements described herein are intended to provide a general understanding of the structure of various embodiments, and they are not intended to serve as a complete description of all the elements and features of apparatus and systems that might make use of the structures described herein. Many other arrangements will be apparent to those of skill in the art upon reviewing the above description. Other arrangements may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

The preceding description has been presented with reference to various embodiments. Persons skilled in the art and technology to which this application pertains will appreciate that alterations and changes in the described structures and methods of operation can be practiced without meaningfully departing from the principle, spirit and scope.

Although the present application has been shown and described with respect to several preferred embodiments thereof, various changes, omissions and additions to the form and detail thereof, may be made therein, without departing from the spirit and scope of the application.

We claim:

1) A configurable web-based system for automating a workflow process in a dynamic production environment across an enterprise application within a communication network, wherein the system comprises:
a deployable workflow engine capable of being integrated with an application server, wherein the deployable workflow engine, via a processor of the application server, stores, at a storage medium, modeled process routing definitions, predefined routing rules, routing types and other workflow process-related information for determining an order in which scheduled instances of activities are routed and enacted for automating the workflow process; and
an execution platform that engages with the deployable workflow engine to create a configurable workflow application by generating customized data definition fields and process-related metadata information, wherein the process-related metadata information is dynamically modeled using a key identifier associated with the data definition fields and a validation mechanism configured to track a sequence of constraint-specific instances of activities.

2) The configurable web-based system of claim 1, wherein the workflow process-related information is stored directly in a relational database at the storage medium.

3) The configurable web-based system of claim 1, wherein the deployable workflow engine processes instances of activity attributes and the predefined routing rules to determine the order in which the scheduled activities can be enacted.

4) The configurable web-based system of claim 1, wherein the modeled process routing definitions, predefined routing rules, routing types, and role-based information forms a part of a workflow configuration that is depicted in a tabular format.

5) The configurable web-based system of claim 1, wherein the execution platform engages with the workflow engine to create the configurable workflow application by including the workflow engine in a class path of another application via remote method invocation calls.

6) The configurable web-based system of claim 1, wherein the workflow engine is available as a deployable enterprise java beans on a java 2 enterprise edition complaint application server.

7) The configurable web-based system of claim 1, wherein the order in which the scheduled instances of activities can be routed and enacted is determined by a routing criterion based on predefined routing rules formed by decision logic.

8) The configurable web-based system of claim 7, wherein the decision logic is defined in apache velocity script.

9) The configurable web-based system of claim 1, wherein the workflow engine is capable of supporting linear, parallel, multi-choice routing, looping, conditional forward, backward and escalation workflow patterns.

10) The configurable web-based system of claim 1, wherein the workflow engine supports a role-based, a user-based, or a weighted-round-robin-based work allocation approach for effective resource utilization in an automated workflow management system.

11) The configurable web-based system of claim 1, wherein process versioning is enabled by the deployable workflow engine by copying an existing process definition to a different process definition without allowing start and end dates of a process for the existing process definition and a process for the different process definition to overlap.

12) The configurable web-based system of claim 1, wherein the system provides flexibility to execute and visualize the workflow process on the application server.

13) A method of automating a workflow process in a dynamic production environment through execution of a sequence of instances of activities of a process flow model across an enterprise application within a communication network, wherein the method comprises the processor implemented steps of:
defining and storing one or more data field definitions, routing definitions, routing rules, routing constraints, and related metadata information to trigger workflow processing;
specifying routing constraints to assign predefined values to valid subsets of the instances of activities;
determining a subset of the valid subsets that is scheduled for enactment based on routing criteria and the routing constraints;
analyzing at least one of the data field definitions, the routing definitions, the routing rules, the routing constraints, the related metadata information and the determined subset, which are received via signals from a storage medium of a workflow engine, to produce workflow models; and
initiating a workflow based on at least one of the data field definitions, the routing definitions, the routing rules, the routing constraints, the related metadata information, the determined subset, and the workflow models produced.

14) The method of claim 13, comprising defining the routing rules based on predefined routing criteria to determine a flow and a pattern of an instance in the workflow process.

15) The method of claim 13, further comprising storing the one or more data field definitions, the routing definitions, the routing rules, the routing constraints and the related metadata information in a workflow database as workflow process configuration tables.

16) A lightweight pluggable tool for creating a workflow process model in a dynamic production environment, the lightweight pluggable tool comprising:
a data modeler that dynamically models, via a processor of an application server, data fields by creating and defining the data fields and assigning a run time value to each of the data fields as key value pairs within a table, wherein the lightweight pluggable tool is configured to integrate with the application server and modeled workflow configurations to create the workflow process model.

17) The lightweight pluggable tool of claim 16, wherein the run time value for each data field is stored as a row of the table along with an identifier in key form.

18) The lightweight pluggable tool of claim 16, wherein each data field enables defining of dependent combinations where a subset of a value for each data field is assigned a predetermined value for triggering a following sequence of activity in a workflow process.

19) The lightweight pluggable tool of claim 18, wherein the lightweight pluggable tool is configured to activate the subset by outputting the predetermined value for display to a user, and wherein the lightweight pluggable tool is further configured to accept a selected value for the subset from the user.

20) The lightweight pluggable tool of claim 16, wherein the lightweight pluggable tool is configured to host multiple users utilizing a platform, and wherein the lightweight pluggable tool is further configured to shield an identity of a user of the multiple users from other users of the multiple users while hosting the multiple users.
